(19) United States
(12) Patent Application Publication
(10) Pub. No.: US 2005/0119411 A1
(43) Pub. Date: Jun. 2, 2005

(54) Polymer composition

(76) Inventors: Takahiko Terada, Kyoto (JP); Tetsuji Kawakami, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/508,907

(22) PCT Filed: Mar. 28, 2003
(86) PCT No.: PCT/JP03/04050

(30) Foreign Application Priority Data
Mar. 29, 2002 (JP) 2002-096455

(51) Int. Cl. C08L 39/04

(52) U.S. Cl. 525/203

(57) ABSTRACT

A flame-retardant polymer composition contains a polymer and a flame retardant, in which the flame retardant includes a polymer having a flame-retardant moiety in a side chain thereof.

### TECHNICAL FIELD

The present invention relates to a polymer composition having low toxicity and a flame retardancy that does not impair the original characteristics of the polymer, and to a method for producing the same.

### BACKGROUND ART

Polymers are classified as combustibles similarly to wood. Therefore, a polymer can not be used as it is for uses in which it is inconvenient that the polymer burns. Therefore, various types of flame retardant are applied to it.

“Polymer (also referred to as “resin” or “plastic”)” used herein includes not only thermoplastic polymers but also thermosetting polymers, and a polymer composition includes mixtures of a polymer and other materials (for example, an inorganic filler).

Generally, flame retardancy is given to a polymer by mixing various flame retardants with it or introducing substituents into the skeletal structure of the polymer. The flame retardants are roughly classified as halogen-based flame retardants and non-halogen-based flame retardants.

As to the halogen-based flame retardants, toxicity by acid gases such as hydrogen bromide and hydrogen chloride that are generated during combustion has been pointed out. Furthermore, recently, it has been considered a problem that dioxin may be generated during its combustion. Therefore, in recent years, non-halogen flame retardants have drawn attention.

As the non-halogen flame retardants, metal hydroxide-based or phosphorus-based flame retardants can be listed. For example, for metal hydroxide such as magnesium hydroxide, the toxicity of the gas generated during combustion is lower compared to that of halogen-based flame retardants, however, there is a problem that its flame retardant performance is poorer. Therefore, in order to make polymer flame-proofed using metal hydroxide, a large amount of metal hydroxide must be mixed with the polymer. As a result, a problem that the characteristics of the polymer are impaired occurs.

Furthermore, a flame-proofed polymer composition in which sulfate of a triazine compound as a non-halogen-based flame retardant is mixed with a thermoplastic polymer is disclosed in Japanese Laid-Open Publication No. 8-48812. However, though this composition shows considerable combustion suppression effect, its flame retardant effect is not sufficient. Therefore, development of a flame retardant and a flame-proofed polymer composition that have more excellent flame retardancy is desired.

From the viewpoint of global environmental problems, exhaustion of resources such as petroleum, and the global warming caused by combustion carried out when disposing polymers that can not be applied with material recycling or chemical recycling are getting more serious and, thus, development of biodegradable polymers is under progress. Especially, development of biodegradable polymers using biomass as their raw material and not using fossil resources such as petroleum is being actively carried out. Among them, when biomass originated from plants such as corns and potatoes that fix carbon dioxide in the atmosphere in a relatively short-term cycle (for example, one (1) year) is used, there is an advantage that there is no contribution to global warming in the long run because the term of a cycle for carbon dioxide to be fixed is short even though carbon dioxide is generated by combustion. Therefore, this is drawing attention.

As described above, it is desired to develop a flame retardant and a flame retardant polymer that generate no toxic gas such as dioxin, do not impair the characteristics of the polymer but have sufficient flame retardant. Furthermore, until present, no technological development has been carried out from the viewpoint of manufacturing a flame retardant using biomass as its raw material or giving biodegradability to a flame retardant itself.

### DISCLOSURE OF THE PRESENT INVENTION

The present invention was made in view of the above and the main objective of the present invention is to provide a polymer composition having low toxicity and a global-environment-friendly flame retardancy, and its manufacturing method.

The above objective is achieved by a polymer composition of the present invention containing a polymer and a flame retardant, wherein the flame retardant includes a polymer having a flame-retardant moiety in a side chain thereof.

The flame-retardant moiety is preferably a compound that, when it is heated, exerts at least one type of reaction selected from a group consisting of endothermic decomposition reaction, radical-compound-producing reaction, inert-gas-producing reaction and incombustibles-producing reaction.

In an embodiment, the thermal decomposition temperature of the polymer having a flame-retardant moiety in a side chain thereof is higher than 100° C. and lower than the thermal decomposition temperature of the polymer.

In an embodiment, the thermal decomposition temperature of the polymer having a flame-retardant moiety in a side chain thereof is in a range that is higher than 300° C. and lower than 550° C.

In an embodiment, the melting point or the softening temperature of the polymer having a flame-retardant moiety in a side chain thereof is equal to or lower than the softening temperature of the polymer.

In an embodiment, the polymer having a flame-retardant moiety in a side chain thereof is contained at a ratio of five (5) part by weight or more and 50 part by weight or less to 100 part by weight of the polymer.

In an embodiment, the polymer having a flame-retardant moiety in a side chain thereof has a heterocyclic compound in which nitrogen is the heteroatom.

In an embodiment, the heterocyclic compound contains at least one kind of compound selected from a group consisting of hydantoin, dimethylhydantoin, triazine, diaminotriazine, acetguanamine, aminotriazole, aminopyridine, isocyanuric acid, imidazole, methylimidazole, triallylcyanulate, triallylisocyanulate, pyrazine, melamine, nucleic acid base, nucleotide and nulcleoside.

In an embodiment, the polymer having a flame-retardant moiety in a side chain thereof is an addition polymer.

In an embodiment, the polymerizing groups in the addition polymer contain at least one kind selected from a group consisting of vinyl, allyl, acrylic and methacrylic groups.

In an embodiment, the polymer having a flame-retardant moiety in a side chain thereof contains a biodegradable polymer.

In an embodiment, the polymer is produced from materials originated from plants.

In an embodiment, the polymer is a polylactic acid-based polymer.

In an embodiment, the polymer contains polystyrene.

In an embodiment, the polymer contains unsaturated polyester.

In an embodiment, the polymer composition has thermoplasticity and can be injection-molded.

In an embodiment, a molded product made of a polymer composition according to the present invention is comprised of any one of the above polymer compositions.

In an embodiment, the molded product contains the flame-retardant moiety in the vicinity of its surface at a density higher than the density inside it.

The molded product according to the present invention is preferably used as a housing for electric appliances.

A method for manufacturing a polymer composition having a flame retardancy according to the present invention includes the steps of preparing a polymer, and a polymerizing compound containing a flame-retardant moiety; and producing a polymer having the flame-retardant moiety in a side chain thereof by heating and kneading the high-molecule material and the polymerizing compound.

In an embodiment, the flame-retardant moiety is a compound that, when it is heated, exerts at least one type of reaction selected from the reaction type group consisting of endothermic decomposition reaction, radical compound-producing reaction, inert gas-producing reaction and incombustibles-producing reaction.

In an embodiment, the polymerizing compound contains a heterocyclic compound in which nitrogen is the heteroatom.

In an embodiment, the high-molecule material contains a biodegradable polymer.

In an embodiment, the polymer contains polystyrene.

In an embodiment, the polymer is rubber-mixed polystyrene and the polymerizing compound is vinyldiaminotriazine.

### BEST MODE FOR CARRYING OUT THE PRESENT INVENTION

Embodiments of the present invention will now be described in detail. In the following description, though examples and comparative examples are listed and described, the present invention is not limited to these examples.

With the aim of providing a polymer composition that has low toxicity and a global-environment-friendly flame retardancy, the inventors carried out research and development and reached this invention from the viewpoint of manufacturing a flame retardant using biomass as its raw material or giving biodegradability to a flame retardant itself.

The flame-proofed polymer composition according to the present invention is a polymer composition containing a polymer and a flame retardant, and the flame retardant contains polymer having a flame-retardant moiety in a side chain thereof.

The flame-proofed polymer composition according to the present invention contains polymer having a flame-retardant moiety in a side chain thereof. Since this polymer has lower dispersibility to polymers than the flame-retardant moiety itself, the polymer is difficult to disperse homogeneously. Therefore, for example, in a molding process such as injection molding, since this polymer is present in the vicinity of the surface of a work (sometimes referred to as “skin layer”) more densely than inside it, a higher flame retardant effect can be obtained than conventional polymer compositions. That is, since, in the polymer composition of the present invention, the flame retardant is present more densely in the vicinity of its surface, where the flame retardant can exert its flame retardant effect, the flame retardancy of the same level as or higher than the conventional level can be obtained with an amount of it to mix, that is less than the conventional ones. Furthermore, since it is made of polymer of flame-retardant moiety, it is more difficult for the characteristics of a polymer (mechanical characteristics) to be lowered by using it than using the flame-retardant moiety as it is (in the form of a low-molecular material). This effect can be obtained by reducing the amount to mix to obtain desired flame retardant and/or making the molecular weight high.

The molecular weight of the flame retardant polymer is preferably 300 to 100,000 and more preferably 500 to 10, 000. As the molecular weight becomes higher, the dispersibility into polymers tends to be degraded. Therefore, compared to the homogeneous dispersion in the case of a low-molecular material, a skin layer is formed in the vicinity of the surface. Therefore, the density of the flame retardant polymer is high and the effect of flame retardant becomes stronger. However, when the molecular weight is too high, the dispersibility of the flame retardant polymer is degraded. Then, degradation of mechanical characteristics, degradation of smoothness of molded items or degradation of moldability caused by aggregation of the flame retardant polymer may occur. Therefore, it is preferable that the molecular weight of the flame retardant polymer is 300 to 100,000.

Furthermore, the molecular weight of a side chain containing the flame-retardant moiety (preferably, a heterocyclic compound in which nitrogen is the heteroatom, described later) in the flame retardant polymer is preferably 500 or less. More preferably, it is 350 or less. As the molecular weight of the side chain becomes higher, reactivity is degraded and the yield is reduced in either of the cases where a side chain is bonded with the polymer by polymer reaction or where the side chain is bonded after the side chain has been bonded with polymeric compound (typically, monomer). Therefore, the molecular weight of the side chain is preferably 500 or less.

Furthermore, the reactivity for bonding the side chain is influenced by the structure of the side chain of the flame retardant polymer. For example, when a heterocyclic compound in which nitrogen is the heteroatom is used as the flame-retardant moiety, as the number of phosphoric acid molecules in a nucleotide becomes larger, the volume becomes larger accordingly and the reactivity is degraded due to the steric hindrance effect. However, as the phosphoric acid portion becomes more, capacity for forming polyphosphoric acid becomes higher and, therefore, the flame retardant effect is high. Therefore, when nucleotide is used as the flame-retardant moiety, diphosphoric acid is most effective among it, monophosphoric acid and triphosphoric acid.

The methods of polymerization for forming polymer contained in the flame retardant in the polymer composition of the present invention includes addition polymerization, condensation polymerization, polyaddition, addition condensation and ring opening polymerization. The addition polymerization is polymerization by monomer having an addition-polymerization group such as vinyl, allyl, acrylic and methacrylic group. The condensation polymerization can include ester polymerization of acid and alcohol, ether polymerization between alcohol and alcohol and amide (nylon) polymerization of acid and amine. Polyaddition can include urethane polymerization by isocyanato group and alcohol and urea polymerization of diisocyanato and diamine. Addition condensation is polymerization consisting of repetition of an addition reaction and a condensation reaction and can include polymerization observed in forming of phenolic resin by phenol and formaldehyde and the polymerization reaction by urea or melamine, and formaldehyde. Ring opening polymerization is polymerization by a cleavage reaction and a growth reaction by lactone, lactam, cyclic ether or formal.

In the case where any of the above polymerization reactions is used, the polymer with the flame-retardant moiety in a side chain thereof may be prepared (synthesized) before mixing with a polymer or may be produced by polymerizing polymeric compound (for example, flame retardant monomer) in the process of mixing it with a polymer. Surely, both of the above may be used in combination.

The flame-retardant moiety contained as the side chain of the flame retardant polymer used as the flame retardant can be selected appropriately from known compounds, however, heterocyclic compounds in which nitrogen is the heteroatom are preferable.

As the heterocyclic compounds in which nitrogen is the heteroatom, at least one compound selected from a group consisting of hydantoin, dimethylhydantoin, triazine, diaminotriazine, acetguanamine, aminotriazole, aminopyridine, isocyanuric acid, imidazole, methylimidazole, triallylcyanulate, triallylisocyanulate, pyrazine, melamine, nucleic acid base, nucleotide and nulcleoside can be listed.

As specific examples will be exemplified later, the polymer having in a side chain thereof a heterocyclic compound in which nitrogen is the heteroatom contains nitrogen atoms. Therefore, it exerts flame retardant action similarly to nitrogen-containing compounds that have been conventionally used as a flame retardant such as, for example, aliphatic series amine compounds, aromatic amine compounds, cyanogen compound, aliphatic amide, aromatic amide, urea and thiourea.

Especially, since the heterocyclic compound in which nitrogen is the heteroatom has a heterocycle containing nitrogen, the compounds are considered to have a strong flame retardant action because, when it is exposed to a high temperature, it suppresses thermal decomposition of polymers by its endothermic decomposition and blocks the supply of fuel as well as decreases the opportunities to contact with oxygen by forming an inert atmosphere (nitrogen gas atmosphere) around the polymer.

Furthermore, it is preferable that the melting point and the softening point of the flame retardant polymer is same as or lower than the molding temperature of the polymer composition. Since the flame retardant polymer is in the form of liquid drops or in another easily movable state when molding the polymer composition and is present locally in the vicinity of and close to the surface, the flame retardant effect is further enhanced.

When addition polymer is used as the flame retardant polymer, at least one group selected from the group consisting of vinyl, allyl, acrylic and methacrylic group as the polymerization group.

When addition polymer is used, it is preferably used for a polymer composition suitable for injection molding and, furthermore, it is easy to produce it in a heating and kneading process.

Among the heterocyclic compounds in which nitrogen is the heteroatom described above, nucleic acid base, nucleotide and nulcleoside are the substances that are all biogenous and have biodegradability. Therefore, different from the compound synthesized from fossil fuel such as petroleum, they are produced from biomass as their raw material and are global-environment-friendly materials having biodegradability.

The flame retardant contained in the polymer composition of the present invention may contain one or more conventional flame retardants in addition to the polymer containing one or more of the above flame-retardant moietys in a side chain thereof. However, in order to obtain the effect of the present invention, it is preferable to use only the polymer having in a side chain thereof a heterocyclic compound in which nitrogen is the heteroatom.

In order to act preferably as the flame retardant of the above polymer composition, it is preferable that the flame-retardant moiety is a compound that, when it is heated, exerts at least one type of reaction selected from the group consisting of endothermic decomposition reaction, radical compound-producing reaction, inert gas-producing reaction and incombustibles-producing reaction. It is preferable that the temperature at which these reactions are exerted (i. e., thermal decomposition temperature) is higher than the processing temperature (such as molding temperature) of the polymer composition and lower than the thermal decomposition temperature of the polymer.

The polymer composition according to the present invention can be processed into molded items in various forms such as sheets, films and housings according to the characteristics of the polymer being mixed. Furthermore, not limited to materials for molding, it can be used as the material for adhesives, paint-and putty. The processing temperature of a common polymer is approximately 100° C. or higher and approximately 300° C. or lower, and the temperature of the common polymers during combustion reach approximately 400° C. or higher and approximately 550° C. or lower (corresponding to the thermal decomposition temperature). Therefore, as the flame retardant polymer, flame retardant polymer having a desired thermal decomposition temperature may be used in response to the kind and/or the processing temperature of the polymer being mixed. That is, flame retardant polymer having the thermal decomposition temperature of 100° C. or higher and 550° C. or less may be used as necessary depending on the use.

The polymer composition of the present invention is especially advantageous in the field that requires high flame retardancy, for example, in use for electric appliances (including electronic devices and electronic parts). Furthermore, the flame retardant polymer according to the present invention can give the flame retardancy to polymers without degrading considerably the mechanical characteristics of the polymers. Therefore, it can be used preferably as the material for bulk molded items such as housings.

As a polymer constituting the polymer composition for these uses, a polymer for which the processing temperature (molding temperature) is approximately 250° C. or higher and approximately 300° C. or lower (typically, so-called general purpose engineering plastic) is used (“plastic” used herein refers to plastic in a narrow sense and thermoplastic resins). It is preferable that the thermal decomposition temperature of the flame retardant polymer is higher than approximately 300° C. such that thermal decomposition does not occur during processing of these types of polymers. Therefore, the advantage of the present invention is especially exerted by using flame retardant polymer having the thermal decomposition temperature of approximately 300° C. or higher and 550° C. or lower.

Thermal decomposition temperature herein is the temperature at which the decrease in weight reaches 10% when the variation of weight is measured under a temperature-increasing condition of 10° C./min. in nitrogen atmosphere using a thermogravimeter (TG).

The mixing composition of the polymer and the flame retardant polymer in the polymer composition of the present invention depends on the kind of the polymer and the flame retardant polymer, and the characteristics required for the final products (for example, flame retardancy and mechanical characteristics). However, generally, it is preferable to contain the above flame retardant polymer at the ratio of five (5) parts or more and 50 parts or fewer by weight in 100 part by weight of the polymer. Since the flame retardant polymer typically takes the form of powder, the bulk density is small and volumetric effect (or surface area effect) is high compared to the ratio of weight. Therefore, it can exert flame retardant action when it is relatively little. However, in order to obtain securely the flame retardant effect, it is preferable to mix five (5) part by weight or more of it and it is more preferable to mix ten (10) part by weight or more of it. On the other hand, when the amount of the flame retardant polymer to be mixed exceeds 50 part by weight, the characteristics of the polymer (for example, mechanical characteristics) may be degraded excessively. Especially, in order to suppress the degradation of the physical properties of the polymer in uses including that for bulk molded items, it is preferable that the amount of the flame retardant polymer to be mixed is 100 part by weight or less and, more preferably, 30 part by weight or less.

Now, specific examples of nucleic acid base, nucleotide and nulcleoside that are the preferable examples of the heterocyclic compound in which nitrogen is the heteroatom, used as the flame-retardant moiety constituting the side chains of the flame retardant polymer will be shown.

As is well known, nucleic acid base is a substance constituting nucleic acid together with pentose and phosphoric acid. Adenine, guanine, cytosine, uracil, thymine and hypoxanthine can be preferably used. Furthermore, sulfate, nitrate, borate, hydrochloride and isocyanurate of these nucleic acid bases can be preferably used. For example, those such as adenine sulfate, guanine hydrochloride and guanine sulfate can be exemplified.

As nucleoside, for example, adenosine, guanosine, cytidine, uridine, thymidine and inosine can be listed.

As nucleotide, for example, adenylic acid, guanylic acid, cytidylic acid, uridylic acid, thymidylic acid and inosinic acid can be preferably used. Furthermore, as metallic salt of nucleotide, 5′-adenylic acid sodium salt, adenosine triphosphate sodium salt, 5′-guanylic acid sodium salt, 5′-uridylic acid sodium salt and 5′-inosinic acid sodium salt can be exemplified.

Compounds produced by substituting hydrogen atoms bonded with nitrogen atoms of the above nucleic acid base, nucleotide and nulcleoside, with an alkyl having one (1) to four (4) carbons, an allyl having six (6) to ten (10) carbons, an alkoxy group or a mercapto group also have flame retardancy. As such a compound, those including 2-methyladenine, 6-diethyladenine, 6-allyladenine can also be used.

Here, as the alkyl having one (1) to four (4) carbons, methyl, ethyl, propyl and butyl can be, for example, listed. As the allyl having six (6) to ten (10) carbons, phenyl, tolyl, xylyl and naphthyl can be, for example, listed. As an alkoxy group, for example, methoxy group, ethoxy group and butoxy group can be listed. When the number of carbon is too many, the flame retardancy may be degraded.

As described above, it is preferable that, especially, the flame retardant polymer used in the polymer composition for bulk molded items has the thermal decomposition temperature of 300° C. or higher and 550° C. or lower. As such a heterocyclic compound in which nitrogen is the heteroatom, adenine, guanine, cytosine, uracil and thymine can be exemplified. The thermal decomposition temperature is the temperature at which the decrease in weight reaches 10% under a heating condition of 10° C./min. in nitrogen atmosphere using a thermal analysis apparatus TAS100 (TG/DTA·DSC) manufactured by Rigaku.

The compounds produced by substituting hydrogen atoms bonded with nitrogen atoms of nucleotide or nulcleoside, with an atom group selected from a group consisting of alkyl having one (1) to four (4) carbons, an allyl having six (6) to ten (10) carbons, an alkoxy group or a mercapto group, have phosphoric acid as its constituent unit. Then, it is considered that these compounds exert flame retardant effect by forming heat resistant coating by producing a polyphosphoric acid compound when they are exposed to a high temperature and/or by a carbonization acceleration mechanism. Therefore, since these compounds have a flame retardant action by phosphoric acid and a flame retardant action by nitrogen-containing heterocycle, a more strong effect can be expected.

As the polymer used for the polymer composition of the present invention, general purpose polymer such as thermoplastic resins such as polystyrene, ABS resin, polyamide resin, polypropylene, polyurethane and PPS resin, and thermosetting resins such as epoxy resin, phenol resin and polyester resin can be used. However, it is preferable to use biodegradable polymer. According to the present invention, by using flame retardant polymer containing nucleic acid base, nucleotide and nucleoside, that is a preferable example of the heterocyclic compound in which nitrogen is the heteroatom, and biodegradable polymer, a biodegradable polymer composition can be obtained. Therefore, it is possible to dispose it by utilizing decomposition by enzyme and/or microorganisms. Furthermore, it can be decomposed when buried underground and can be incorporated into the natural material circulation.

As the biodegradable polymer, polymer obtained by ring opening polymerization of lactone such as polycaprolactone and polypropiolactone, polymer of hydroxy acid such as polylactic acid and polyglycolic acid, copolymer consisting of glycol and aliphatic dicarboxylic acid such as polyethyleneadipate, polybutyleneadipate, polytetramethyleneadipate, polyechylenesuccynate, polybutylenesuccynate, polymer having a functional group at an end such as polycaprolactonediol and polycaproralconetoriol, and polyester obtained by fermentation by microorganisms 3-hydroxypropionate, 3-hydroxybutylate, 3-hydroxyvalilate, 3-hydroxyoctanolate can be preferably used.

Among the biodegradable polymer, polymer produced using biomass originated from plants, to which carbon dioxide in the atmosphere is fixed in a relatively short cycle (for example, one (1) year) is especially preferable. These types of polymer have advantages that they do not need fossil resources and, in addition, they will not contribute to the global warming in the long run because a cycle for carbon dioxide to be fixed is short even though carbon dioxide is generated by combustion. As such a polymer, there are, for example, a polymer produced from raw materials such as starch which is the main component of corns and potatoes, cellulose which is the main component of plants and straws or succharide such as glucose which is the constituent unit of cellulose, and polylactic acid and cellulose acetate can be exemplified.

When exposed to a high temperature, in the polymer having in its side chain a nitrogen-containing heterocycle used in the present invention, the side chain carried out endothermic decomposition of the nitrogen-containing heterocycle and takes heat from the polymer being mixed, and forms inert atmosphere. Therefore, it is flame retardant polymer that shows a flame retardant effect of the polymer. As the monomer having in its side chain a nitrogen-containing heterocycle, allylhydantoin, vinyl-4,6-diamino-1,3,5-triazine can be listed. As the nitrogen-containing heterocycle, triazine and nucleic acid bases selected from nucleic acid base, nucleotide and nucleoside can originate it. Examples of it are allyladenine, allyladenosine, allylinosine, amide compounds of methacrylic acid and adenine or adenosine.

Polymer formed by polymerizing monomer having a nitrogen-containing heterocycle in a side chain thereof may be mixed with the polymer. Otherwise, the polymerization of the monomer having a nitrogen-containing heterocycle in a side chain thereof may also be accelerated by heating and kneading it during the process in which it is mixed with the polymer. By starting mixing the monomer as it is and polymerizing it while kneading it, it makes an excellent blend at the initial stage of the kneading and this facilitates mixing. However, due to the heating during the kneading or molding, it is polymerized and is phase-separated from the polymer and its dispersibility is degraded. Then, it forms a skin layer and the probability of being present in the vicinity of the surface increases. Consequently, the flame retardant effect is enhanced.

The polymer composition of the present invention may contain the conventional known additives when necessary within the range that does not impair the effect of the present invention.

As examples of them, oxidation inhibitors (such as phenol-based, phosphite-based and thioether-based ones), weather-resistant agents (such as benzophenone-based, salicylate-based, benzotriazole-based, hindered-amine-based), metal deactivators, halogen scavengers, lubricants (such as olefin, aliphatic acid and derivatives of aliphatic acid), crystallization core agents (such as metallic salt, talc, sorbitol-based ones), fillers (talc, calcium carbonate, barium sulfate, glass fiber, mica), blooming inhibitors, antiblocking agents, antitarnishing agents, gluing agents, coloring agents, delustering agents, antistatic agents, adsorbing agents for oxygen or carbon dioxide, gas-adsorbing agents, freshness maintaining agents, enzymes, deodorants, perfumes can be listed.

The polymer composition of the present invention can be obtained by mixing, melting and kneading after mixing the raw material components. The order of mixing each component and the kneading method are not limited especially. The mixing and the kneading may be carried out according to the ordinary method using, for example, a kneader, a mixing roll, a tumbler-type blender, a V-shaped blender, a henshell mixer, a ribbon mixer. Furthermore, melting and kneading methods are not limited especially and may be performed at a temperature equal to or higher than the melting point of the thermoplastic resins using, for example, a screw extruder, a heating-type kneader, a banbury mixer, a heating-type mixing roll. This melting and kneading process may be performed in an inert gas flow such as nitrogen gas.

The polymer composition of the present invention can be used preferably for various bulk molded items for which flame retardant is required. As examples of such molded items, parts and covers of various electric appliances (such as washing machine, refrigerator, dish dryer, rice cooker, electric fan, ventilating fan, television, personal computer, stereo set, telephone, microwave oven, warm toilet and iron), parts and covers of light and heat appliances (such as air conditioner, heater, cooking stove, fan heater and hot-water supplier), interior material and exterior material of buildings, and parts or interior material of cars, ships and airplanes can be listed.

Now, examples according to the present invention and comparative examples will be described.

### EXAMPLES 1 TO 7 AND COMPARATIVE EXAMPLES 1 TO 10

First, specimens of Examples 1 to 7 of the polymer composition according to the present invention and Comparative Examples 1 to 10 of polymer composition in which a conventional flame retardant is dispersed were produced. The mixing ratio of each specimen is shown in Tables 1 and 2.

For polymer composition using a thermoplastic polymer, each specimen was produced by heating it to the melting temperature of the polymer or higher and mixing it with a flame retardant. The obtained polymer composition was molded into pelletized form using an injection molding machine. As the standard conditions for molding, the mold temperature was set at 60° C., the injection pressure at 80 MPa, the injection time period at 10 sec. (cooling time period at 40 sec.), the injection speed at 40 mm/sec., respectively, and the molding was performed adjusting these conditions depending on the material used. In addition, as specimens for flame retardant tests, strip specimens having the dimensions of 12.7 mm×3 mm×127 mm using compression molding (applied pressure of 4.9 MPa) were produced. As to the polymer composition using the thermosetting polymer, after it was mixed in the form of prepreg with flame retardants, it was hot-set to produced test specimens.

The flame retardant test was performed according to UL94 Safety Standard “Burning Tests of Plastic Material for Parts of Appliances” using the above specimens. As the burning tests, Horizontal Burning Test 94HB (reference standard: ASTM-D635) and 20 mm Vertical Burning Test 94V (reference standard ASTM-D3801) were performed.

In 94HB test, when burning speed does not exceed 40 mm/min. in a section of 75 mm or when combustion stops before reaching a length of 75 mm, the specimens were classified as 94HB (represented by “HB” in the tables).

In 94V test, for five (5) specimens, when the flame-remaining time is ten (10) sec. or less for any of the five (5) specimens, when the total of the flame-remaining time of all the specimens is 50 sec. or less, or when the total of the flame-remaining time after contacting flame and the cinder-remaining time is 30 sec. or less for each specimen, the specimens were classified as 94V0 (represented by “V-0” in the tables).

TABLE 1

| | | | Flame | |
|---|---|---|---|---|
| | | | Retardancy | |
| | Polymer | Flame Retardant | ⅛ | 1/16 |
| Example | [by weight] | [by weight] | Inch | Inch |
| 1 | Polystyrene | Allylhydantoin | V-0 | V-0 |
| | 100 parts | 30 parts | | |
| 2 | Polystyrene | Vinyl-4,6-diamino- | V-0 | V-0 |
| | 100 parts | 1,3,5-triazine | | |
| | | 30 parts | | |
| 3 | ABS Resin | Methacrylic | V-0 | V-0 |
| | 100 parts | Acid-Adenine | | |
| | | 20 parts | | |
| 4 | Epoxy Resin | Methacrylic | V-0 | V-0 |
| | 100 parts | Acid-Adenosine | | |
| | | 20 parts | | |
| 5 | Polylactic | Allylhydantoin | V-0 | V-0 |
| | Acid | 30 parts | | |
| | 100 parts | | | |
| 6 | Polybutylene-succynate | Vinyl-4, | V-0 | V-0 |
| | 100 parts | 6-diamino-1,3,5- | | |
| | | triazine | | |
| | | 30 parts | | |
| 7 | Cellulose | Allyladenine | V-0 | V-0 |
| | Acetate | 20 parts | | |
| | 100 parts | | | |

As to allhydantoin used as the flame retardant for Examples 1 and 5, and vinyl-4,6-diamino-1,3,5-triazine used as the flame retardant for Examples 2 and 6, those commercially marketed from Kanto Kagaku Co., Ltd. were used. The flame retardant monomer (monomer) for Examples 3, 4 and 7 was synthesized as follows.

### EXAMPLE 3

5.35 g of adenine (for example, produced by Yamasa Soy Source Co., Ltd.) and 3.2 g of sodium hydroxide were put in 100 ml of water to obtain Solution 1. Then, 4.23 g of methacryloyl chloride (for example, from Wako Junyaku Kogyo Co., Ltd.) was resolved in 100 ml of chloroform to obtain Solution 2. Then, Solution 1 was strongly stirred. Solution 2 was added to Solution 1 through a drop-feed funnel at one time. Then, monomer in the form of fine powder precipitated immediately. This powder was filtered, rinsed with water sufficiently, then, rinsed with methanol sufficiently, dried at a reduced pressure at 60° C. to obtain monomer. The infrared absorption of the monomer was checked using KBr tablet method and the absorption wavelength by amide bonding could be verified. This monomer was methacrylic acid-adenine and was used as the monomer for the flame retardant polymer for Example 3.

### EXAMPLE 4

10.60 g of adenosine (for example, produced by Yamasa Soy Source Co., Ltd.) and 3.2 g of sodium hydroxide were put in 100 ml of water to obtain Solution 3. Then, 4.23 g of methacryloyl chloride was resolved in 100 ml of chloroform to obtain Solution 4. Then, Solution 3 was strongly stirred. Solution 3 was added to Solution 4 through a drop-feed funnel at one time. Then, monomer in the form of fine powder precipitated immediately. This powder was filtered, rinsed with water sufficiently, then, rinsed with methanol sufficiently, dried at a reduced pressure at 60° C. to obtain monomer. The infrared absorption of the monomer was checked using KBr tablet method and the absorption wavelength by amide bonding could be verified. This monomer was methacrylic acid-adenosine and was used as the monomer for the flame retardant polymer for Example 4.

### EXAMPLE 7

5.35 g of adenine and 3.2 g of sodium hydroxide were put in 100 ml of water to obtain Solution 5. Then, 3.09 g of allyl chloride was resolved in 100 ml of chloroform to obtain Solution 6. Then, Solution 5 was strongly stirred. Solution 6 was added to Solution 5 through a drop-feed funnel at one time. Then, monomer in the form of fine powder precipitated immediately. This powder was filtered, rinsed with water sufficiently, then, rinsed with methanol sufficiently, dried at a reduced pressure at 60° C. to obtain monomer. The infrared absorption of the monomer was checked using KBr tablet method and the absorption wavelength by amide bonding could be verified. This monomer was allyladenine and was used as the monomer for the flame retardant polymer for Example 7.

TABLE 2

| | | | Flame | |
|---|---|---|---|---|
| | | | Retardancy | |
| Comparative | Polymer | Flame Retardant | ⅛ | 1/16 |
| Example | [by weight] | [by weight] | Inch | Inch |
| 1 | Polystyrene | Ethylendiamine phosphate | HB | HB |
| | 100 parts | 30 parts | | |
| 2 | Polystyrene | Magnesium hydroxide | HB | HB |
| | 100 parts | 30 parts | | |
| 3 | Polystyrene | Tetrazole ammonium | HB | HB |
| | 100 parts | salt | | |
| | | 30 parts | | |
| 4 | Polystyrene | Melamine | HB | HB |
| | 100 parts | 100 parts | | |
| 5 | Polystyrene | Melamineisocyanuric salt | HB | HB |
| | 100 parts | 30 parts | | |
| 6 | Polystyrene | Tetrabromobisphenol A | V-0 | V-0 |
| | 100 parts | 30 parts | | |
| 7 | Polystyrene | Trisfernyl phosphate | HB | HB |
| | 100 parts | 30 parts | | |
| 8 | Polystyrene | Melamine sulfate | HB | HB |
| | 100 parts | 30 parts | | |
| 9 | Polystyrene | Melamine sulfate | V-0 | V-0 |
| | 100 parts | 100 parts | | |
| 10 | Polystyrene | Benzoguanamine sulfate | V-0 | V-0 |
| | 100 parts | 100 parts | | |

The polymer compositions for above Examples 1 to 7 and Comparative Examples 1 to 10 showed almost no difference in terms of the basic physical properties such as moldability and mechanical strength.

On the other hand, reviewing the flame retardancy, the polymer composition for Examples 1 to 7 of the present invention are all had a flame retardancy corresponding to the grade of V-0. Whereas, as to the polymer composition for Comparative Examples, Comparative Example 6 that used tetrabromobisphenol A that is a halogen-based flame retardant and Comparative Examples 9 and 10 in which 100 part by weight of the flame retardant described in the Japanese Laid-Open Publication No. 8-48812 was respectively mixed marked V-0. However, Comparative Examples with other mixings marked the HB grade. Though only 30 part by weight or less of flame retardant polymer were respectively mixed in each of the polymer composition for Examples of the present invention, it can be seen that the Examples showed an excellent flame retardancy.

Furthermore, the flame retardant polymer for Examples 3 to 7 was produced from biomass as raw material (nucleic-acid-related substance) and is a global-environment-friendly material. Yet furthermore, the polymer of the polymer composition for Example 5 to 7 is also produced from biomass as raw material and the polymer composition containing a flame retardant is constituted by biomass. Then, it is also an ideal material for global environment.

### EXAMPLES 8 AND 9

In the above Examples 1 to 7, examples of producing the flame retardant polymer by polymerizing the flame retardant monomer with a polymer while heating and kneading them. However, it may be mixed (kneaded) with the polymer after preparing the flame retardant polymer in advance.

Here, as shown in the following Table 3, the case where the flame retardant polymer obtained by addition polymerization of monomer having a nitrogen-containing heterocycle was mixed with a polymer (Example 8) and the case where the flame retardant polymer was produced while heating and kneading the monomer (polymerizing compound) having a nitrogen-containing heterocycle and the polymer (Example9) are compared. As the polymer, high-impact polystyrene that is rubber-mixed polystyrene was used.

TABLE 3

| | | | Flame- | | Maximal |
|---|---|---|---|---|---|
| | | | retardancy | | Exothermic |
| | Polymer | Flame Retardant | ⅛ | 1/16 | rate |
| Example | [by weight] | [by weight] | Inch | Inch | [kW/m²] |
| 8 | High Impact | Poly(vinyl-4, | V-0 | V-0 | 500 |
| | Polystyrene | 6-diamino-1,3, | | | |
| | 100 parts | 5-triazine) | | | |
| | | 30 parts | | | |
| 9 | High Impact | Vinyl-4, | V-0 | V-0 | 400 |
| | Polystyrene | 6-diamino-1,3, | | | |
| | 100 parts | 5-triazine | | | |
| | | 30 parts | | | |

As can be seen from the result shown in Table 3, the polymer composition for Example 8 also has an excellent flame retardancy. However, comparing the maximal exothermic rate measured by a Korn calorie meter, the polymer composition for Example 9 showed a slower maximal exothermic rate than Example 8 and it can be seen that Example 9 is more excellent in flame retardancy. It is considered that this is because the flame retardant polymer more easily tend to be locally present in the vicinity of the surface of the molded items when the flame-retardant moiety having a polymerizing property is polymerized while it is heated and kneaded with the polymer. Comparing the appearance of the molded items of Example 8, Example 9 and high-impact polystyrene added with no flame retardant, the smoothness of the surface increases in the order of the one with no flame retardant, Example 8 and Example 9 and the level of whiteness of the surface also increases in the same order. Also from this fact, it is considered that Example 9 had, in its surface, a higher ratio of the flame retardant polymer contained than that of Example 8. Furthermore, it is considered that the flame retardancy of Example 9 is further improved because the flame retardant polymer is dispersed more finely in Example 9.

The compositions and the production methods of the flame retardant polymer composition according to the present invention are not limited to the Examples and, fillers such as calcium carbonate, calcium silicate, barium sulfate, aluminum hydroxide, talc, mica, reinforcement such as glass fiber and carbon fiber and, in addition, viscosity increaser, mold releasing agent and coloring agent may be, for example, mixed.

Furthermore, in the above Examples, specimens molded in strips were used. However, specimens are not limited to this type and they may be molded items having other shapes, paint, putty and adhesives.

### INDUSTRIAL APPLICABILITY

According to the present invention, a polymer composition that has low toxicity and a global-environment-friendly flame retardancy, and its manufacturing method are provided. According to the present invention, the amount of the flame retardant to be mixed can be reduced compared to the conventional cases while a polymer composition having a flame retardancy equal to or more excellent than the conventional flame retardancy can be obtained. In addition, by using polymer produced from biomass as a flame retardant, a flame retardant that does not contribute to exhaustion of resources and global warming and a polymer composition using this agent are provided.

The polymer composition of the present invention can be molded by transfer molding, compression molding or injection molding.

The final molded items obtained from the polymer composition of the present invention can be used in various fields such as furniture, household utensils such as general merchandises, construction material, civil engineering material, body and parts for transportation machines, home appliances, decorated boards, ornaments.

1. A polymer composition containing a polymer and a flame retardant, wherein the flame retardant comprises a polymer having a flame-retardant moiety in a side chain thereof.

2. A polymer composition according to claim 1, wherein the flame-retardant moiety is a compound that, when it is heated, exerts at least one type of reaction selected from a group consisting of endothermic decomposition reaction, radical-compound-producing reaction, inert-gas-producing reaction and incombustibles-producing reaction.

3. A polymer composition according to claim 1, wherein the thermal decomposition temperature of the polymer having a flame-retardant moiety in a side chain thereof is higher than 100° C. and lower than the thermal decomposition temperature of the polymer.

4. A polymer composition according to claim 1, wherein the thermal decomposition temperature of the polymer having a flame-retardant moiety in a side chain thereof is in a range that is higher than 300° C. and lower than 550° C.

5. A polymer composition according to claim 1, wherein the melting point or the softening temperature of the polymer having a flame-retardant moiety in a side chain thereof is equal to or lower than the softening temperature of the polymer.

6. A polymer composition according to claim 1, wherein the polymer having a flame-retardant moiety in a side chain thereof is contained at a ratio of five (5) part by weight or more and 50 part by weight or less to 100 part by weight of the polymer.

7. A polymer composition according to claim 1, wherein the polymer having a flame-retardant moiety in a side chain thereof has a heterocyclic compound in which nitrogen is the heteroatom.

8. A polymer composition according to claim 7, wherein the heterocyclic compound contains at least one kind of compound selected from a group consisting of hydantoin, dimethylhydantoin, triazine, diaminotriazine, acetguanamine, aminotriazole, aminopyridine, isocyanuric acid, imidazole, methylimidazole, triallylcyanulate, triallylisocyanulate, pyrazine, melamine, nucleic acid base, nucleotide and nulcleoside.

9. A polymer composition according to claim 1, wherein the polymer having a flame-retardant moiety in a side chain thereof is an addition polymer.

10. A polymer composition according to claim 9, wherein the polymerizing groups in the addition polymer contain at least one kind selected from a group consisting of vinyl, allyl, acrylic and methacrylic groups.

11. A polymer composition according to claim 1, wherein the polymer contains a biodegradable polymer.

12. A polymer composition according to claim 1, wherein the polymer is produced from materials originated from plants.

13. A polymer composition according to claim 12, wherein the polymer is a polylactic acid-based polymer.

14. A polymer composition according to claim 1, wherein the polymer contains polystyrene.

15. A polymer composition according to claim 1, wherein the polymer contains unsaturated polyester.

16. A polymer composition according to claim 1, wherein the polymer composition has thermoplasticity and can be injection-molded.

17. A molded product made of polymer composition according to claim 1.

18. A molded product according to claim 17, wherein the molded product contains the flame-retardant moiety in the vicinity of its surface at a density higher than the density inside it.

19. A housing for electric appliances made of the polymer composition according to claim 1.

20. A method for manufacturing a polymer composition having a flame retardancy, comprising the steps of:
preparing a polymer, and a polymerizing compound containing a flame-retardant moiety; and
producing a polymer having the flame-retardant moiety in a side chain thereof by heating and kneading the high-molecule material and the polymerizing compound.

21. A method for manufacturing a polymer composition according to claim 20, wherein the flame-retardant moiety is a compound that, when it is heated, exerts at least one type of reaction selected from the reaction type group consisting of endothermic decomposition reaction, radical compound-producing reaction, inert gas-producing reaction and incombustibles-producing reaction.

22. A method for manufacturing a polymer composition according to claim 21, wherein the polymerizing compound contains a heterocyclic compound in which nitrogen is the heteroatom.

23. A method for manufacturing a polymer composition according to claim 20, wherein the high-molecule material contains a biodegradable polymer.

24. A method for manufacturing a polymer composition according to claim 20, wherein the polymer contains polystyrene.

25. A method for manufacturing a polymer composition according to claims 24, wherein the polymer is rubber-mixed polystyrene and the polymerizing compound is vinyldiaminotriazine.
